(19) United States
(12) Patent Application Publication
(10) Pub. No.: US 2020/0209859 A1
(43) Pub. Date: Jul. 2, 2020

(54) METHOD OF VEHICLE LOCALIZATION USING PASSIVE ROADWAY DETECTION DURING A MINIMUM RISK MANEUVER

(71) Applicant: Continental Automotive Systems, Inc., Auburn Hills, MI (US)

(72) Inventor: Xian Zhang, Shelby Township, MI (US)

(21) Appl. No.: 16/554,966

(22) Filed: Aug. 29, 2019

Related U.S. Application Data
(60) Provisional application No. 62/785,350, filed on Dec. 27, 2018.

(51) Int. Cl. G05D 1/00; G05D 1/02; G01H 1/00

(52) U.S. Cl. CPC G05D 1/0088; G05D 1/0231; G05D 2201/0213; G01H 1/00; G05D 1/027

(57) ABSTRACT

A method of detecting a roadway shoulder in an at least partially autonomous vehicle, during a minimum risk maneuver, comprising sensing a vibration within a vehicle, identifying a frequency of the vibration, and determining whether the vehicle is in contact with rumble strips in response to the identified frequency, when at least one or more sensors in a typical known sensor system is compromised.

### CROSS-REFERENCE TO RELATED APPLICATION

This application claims priority to U.S. Provisional Application No. 62/785,350 filed on Dec. 27, 2018.

### TECHNICAL FIELD

The present disclosure relates to a system and method for detecting when an at least partially autonomous vehicle is approaching and/or encountering a roadway shoulder when at least one perception sensor is compromised.

### BACKGROUND

Vehicles with autonomous controls and features utilize sensors to determine a location relative to other vehicles, objects and the boundaries of the roadway. The sensors can include cameras, radar, LIDAR and other known sensors. Fully autonomous vehicles are even more reliant on sensors for control, including but not limited to positional location and/or navigation. If one of the sensors is not functioning or a camera is blocked some lack of functionality can occur. However, the vehicle will still need to determine and identify the boundaries of the roadway.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vehicle, that is at least partially autonomous, proceeds down the roadway with limited or without driver input. During a minimum risk maneuver, for example, slow to stop, stop or change lanes, known sensors are used to provide input to the vehicle for positional identification and/or navigation. In some instances, however, one or more of the typical known sensors are blocked and/or otherwise unable to provide the required information. In these situations, it is important that the vehicle is still able to identify its location in relation to the roadway shoulder, during a minimum risk maneuver. Accordingly, the example vehicle disclosed herein includes a system and method that helps the vehicle to identify and/or be more confident about its location with respect to the roadway shoulder, during a minimum risk maneuver, when the typical known sensor system compromised.

### BRIEF DESCRIPTION OF THE FIGURES

The various features and advantages of the disclosed examples will become apparent to those skilled in the art from the detailed description. The figures that accompany the detailed description can be briefly describes as follows:

FIG. 1 illustrates a vehicle proceeding down a roadway, toward a roadway shoulder including a plurality of rumble strips.

FIG. 2 schematically illustrates a vehicle according to one embodiment of the present invention.

FIG. 3 schematically illustrates a vibration resulting from a vehicle contacting a plurality of rumble strips.

### DETAILED DESCRIPTION

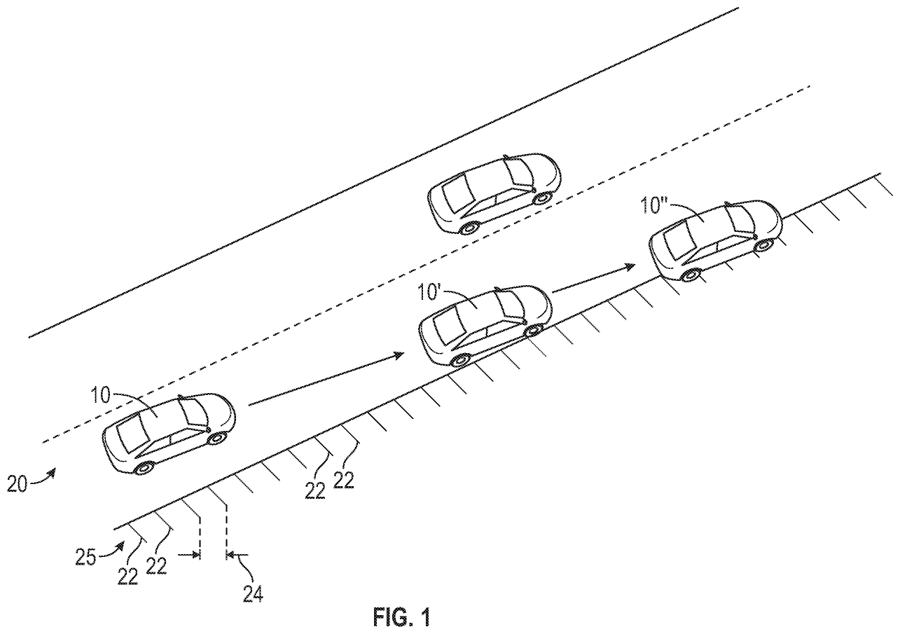

Referring to FIG. 1, a vehicle 10 is shown proceeding down a roadway 20 that includes a shoulder 25 with a plurality of rumble strips 22 spaced a distance 24 apart. The vehicle 10 includes features that detect when the vehicle 10 moves off the roadway and onto the shoulder 25. The disclosed example vehicle 10 is at least partially autonomous and therefore proceeds down the roadway with limited or without driver input. During a minimum risk maneuver, sensors are utilized to provide input to the vehicle for positional identification and/or navigation. In some instances, one or more of the typical sensors are blocked and/or not able to provide the required information. The example vehicle disclosed herein includes a system and method that helps the vehicle to identify and/or be more confident about its location with respect to the shoulder 25, during a minimum risk maneuver, when the typical sensor system compromised.

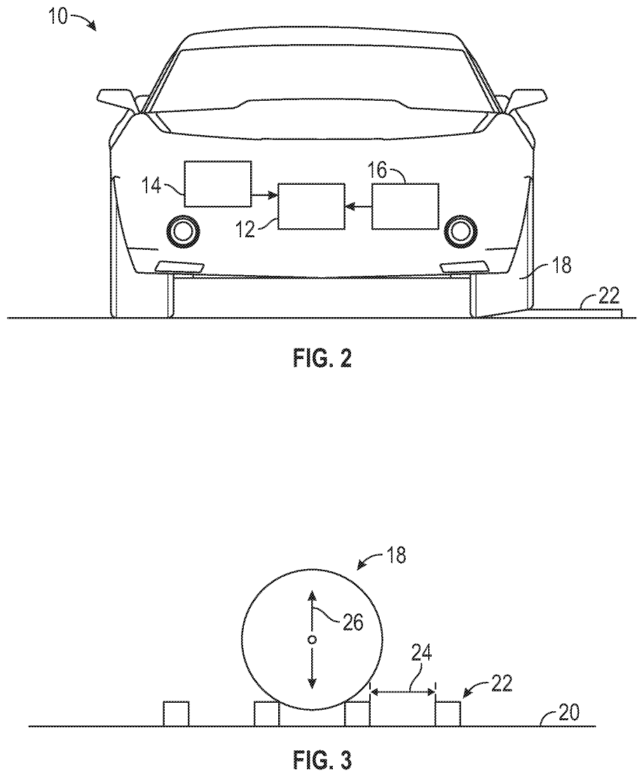

Referring to FIG. 2, with continued reference to FIG. 1, the example vehicle 10 includes a perception sensor 12, a vibration sensor 14 and a controller 16. The perception sensor 12 and the vibration sensor 14, schematically illustrated at a front of the vehicle 10, could be located at other locations within the vehicle 10. Further, it should be noted that, the perception sensor 12 may include a multiple of perception sensors located at various locations around a perimeter of and/or within the vehicle. In the disclosed embodiment, the perception sensor 12 includes at least one camera, which captures images utilized for positional location and/or navigation of the vehicle 10.

The controller 16 is in communication with the perception sensor 12 and the vibration sensor 14. The controller 16 may also include or be in communication with other sensor systems that provide information to navigate the vehicle 10 autonomously. The disclosed system provides a method and system that identifies the road shoulder 25 when the perception sensor or, in one example, camera 12 is compromised, providing an added level of confidence and redundancy for the lateral localization of the road shoulder 25 during a minimum risk maneuver.

The disclosed system utilizes an inertial measurement unit (IMU) as the vibration sensor 14 that is present within the vehicle 10. The IMU 14 has at least a primary function and a secondary function. The secondary function is to sense a vibration within the vehicle 10, where the sensed vibration is then used to determine whether the vehicle 10 is in contact with the plurality of rumble strips 22.

The IMU 14 in one disclosed embodiment is a vertical accelerometer positioned within the vehicle 10. The IMU 14 may be provided as part of another system within the vehicle 10 or be a sensor dedicated to the disclosed system and/or method.

As shown in FIG. 1, as the vehicle 10 moves toward the shoulder, as indicated by vehicle 10′, it approaches the plurality of rumble strips 22. When the vehicle 10 is executing a minimum risk maneuver and reaches the plurality of rumble strips 22, as indicated at 10″ the tires 18 will touch the plurality of rumble strips 22 resulting in a vibration, indicated schematically at 26 in FIG. 3.

The IMU 14 senses the vibration 26, which will be in a vertical direction with a strong frequency within a specific range. The range of the strong frequency will be related to a speed of the vehicle 10 along with a spacing 24 of the plurality of rumble strips 22.

The IMU 14 generates a signal based upon the sensed vibration 26. The signal is processed by the controller 16 using signal processing and analysis techniques, for example, a roadside identification algorithm, to identify the frequency of the vibration 26. The identified frequency is then correlated with an expected signal that, when occurring within a predefined range, is indicative of the vehicle 10 approaching the shoulder 25. More specifically, the identified frequency of the vibration 26 is used to determine whether the vehicle 10 is in contact with the plurality of rumble strips 22.

The information from the IMU 14 can be utilized alone or combined with other sensor information by the controller 16. The information from the IMU 14 can be utilized alone to determine when the vehicle 10 has approached and is on the shoulder 25 when sensors, such as the camera 12, are compromised or blocked. Alternatively, the information from the IMU 14 can be combined with other sensor information, which may be available to enhance confidence in the positional identification, to determine that the vehicle 10 has approached and is on the shoulder 25.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of detecting a roadway shoulder comprising:
sensing a vibration within a vehicle;
identifying a frequency of the vibration; and
determining whether the vehicle is in contact with rumble strips in response to the identified frequency.

2. The method as recited in claim 1, wherein the vehicle is determined to be in contact with the rumble strips when the identified frequency is within a predefined range.

3. The method as recited in claim 1, wherein the vibration within the vehicle is sensed with an inertial measurement unit.

4. The method as recited in claim 3, wherein the inertial measurement unit comprises at least a primary function and a secondary function.

5. The method as recited in claim 4, wherein the secondary function of the inertial measurement unit is to sense the vibration within the vehicle used to determine whether the vehicle is in contact with the rumble strips; and
the primary function of the inertial measurement unit is different from the secondary function.

6. The method as recited in claim 3, wherein the inertial measurement unit comprises a vertical accelerometer.

7. The method as recited in claim 1, wherein the vehicle comprises an autonomous vehicle.

8. The method as recited in claim 7, wherein the autonomous vehicle includes a perception sensor.

9. The method as recited in claim 8, wherein the autonomous vehicle utilizes the determination of whether the vehicle is contact with the rumble strips to detect the roadway shoulder when the perception sensor is compromised.

10. The method as recited in claim 8, wherein the perception sensor comprises a camera for capturing images utilized for navigation of the vehicle.

11. The method as recited in claim 10, wherein the autonomous vehicle utilizes the determination when the camera is blocked.

12. The method as recited in claim 1, wherein the roadway shoulder is detected when it is determined that the vehicle is in contact with the rumble strips.

13. The method as recited in claim 1, wherein the step of determining further comprises analyzing the identified frequency based on a roadside identification algorithm.

14. The method as recited in claim 13, wherein the analysis further comprises receiving information from at least one other sensor as an input into the roadside identification algorithm.

15. A system for detecting a roadway shoulder comprising:
a sensor sensing vibration within a vehicle;
a controller configured to identify a frequency of a vibration sensed by the sensor and determine a contact with rumble strips in response to the identified frequency.

16. The system as recited in claim 15, wherein contact with the rumble strips is determined when the identified frequency is within a predefined range.

17. The system as recited in claim 15, wherein the sensor comprises at least a primary function and a secondary function, different from the primary function.

18. The system as recited in claim 15, wherein the secondary function of the sensor is to sense the vibration within the vehicle used to determine whether the vehicle is in contact with the rumble strips.

19. The system as recited in claim 15, wherein the sensor comprises an inertial measurement unit.

20. The system as recited in claim 15, wherein the vehicle is an autonomous vehicle.
